(19) United States
(12) Patent Application Publication
(10) Pub. No.: US 2002/0176252 A1
(43) Pub. Date: Nov. 28, 2002

(54) Three-dimension curtain-type lighting string

(76) Inventor: Wun-Fang Pan, Hsinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/861,604

(22) Filed: May 22, 2001

(51) Int. Cl. F21V 21/00

(52) U.S. Cl. 362/249

(57) ABSTRACT

The present invention is to provide a three-dimension curtain-type lighting string, which includes a frame being formed by several layers of connecting beams The frame is capable of being connected with many hanging strings with different length for becoming a three-dimension decoration. The frame can be easily fixed under the ceiling to obtain a special and improved decorative lighting effect

### BACKGROUND OF THE INVENTION

A conventional curtain-type lighting string includes a main straight electrical wire, which includes several branch strings in parallel. In use, as shown in FIG. 1, the curtain-type lighting string displays a plan structure. That is the known string is a two-dimension decoration, which can only be hanged on the wall without obvious decorative effect.

Accordingly, the primary object of the invention is to provide a three-dimension curtain-type lighting string, which includes a frame to connect with hanging strings for obtaining a three-dimension decoration with improvement. Now the features and advantages of the present invention will be described in detail with reference to the accompanying drawings.

### BRIEF DESCRIPTION OF ACCOMPANYING DRAWINGS

FIG. 1 is a plan view showing a prior curtain-type lighting string.

FIG. 2 is a perspective view showing a three-dimension curtain-type lighting string according to the present invention.

FIG. 3 is a perspective view showing a frame of FIG. 3.

FIG. 4 is a perspective view showing another modified frame according to the present invention.

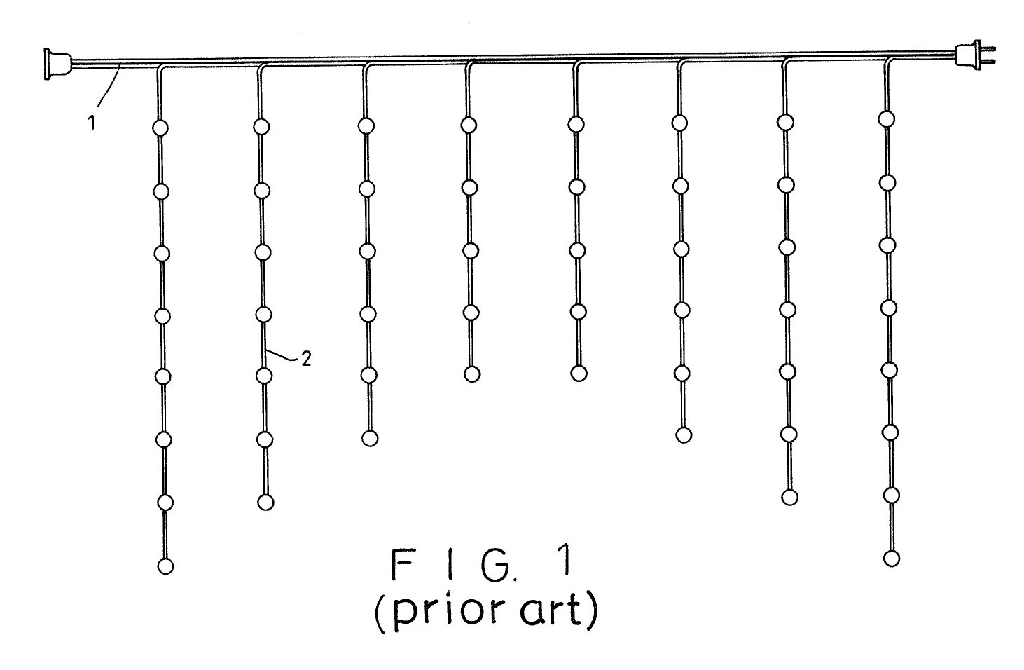

### DETAILED DESCRIPTION OF PREFERRED EMBODIMENTS

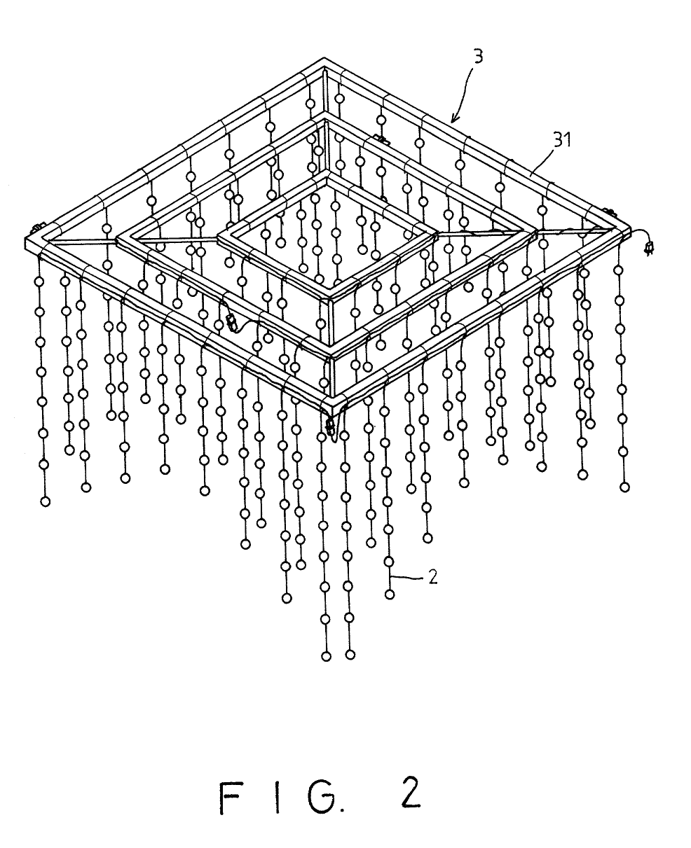

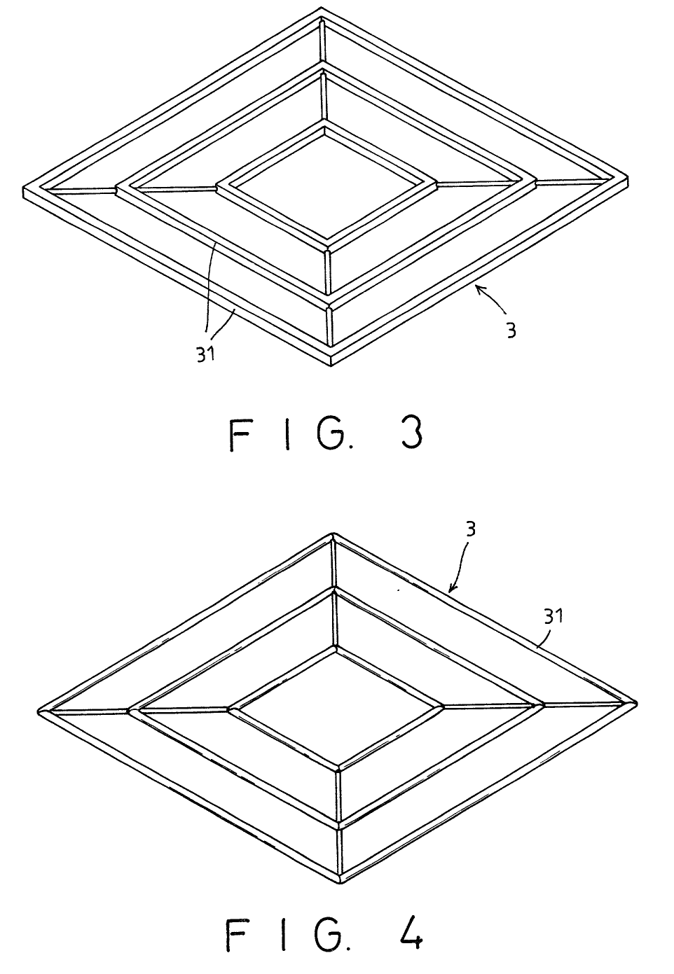

Referring to FIGS. 2 and 3, the present invention is to provide a three-dimension curtain-type lighting string, which includes a supporting frame (3) being assembled by several connecting beam (31). Many lighting strings (2) having different length are combined with the beam (31) and being hanged thereon to become a three-dimension structure, as shown in FIG. 2. The hanging string connected on the frame (3) with different length can display special decorative effect unlike a prior art. In use, the frame (3) can be easily mounted under the ceiling and the whole assembly obtains a best lighting decoration.

The beam (31) of the frame (3) in previous embodiment is rectangular for example. It is to be understood that the beam (31) can be provided with other shapes of various cross sections, such as round in FIG. 4, or polygonal structure. Moreover, the frame (3) is formed by three layers of rectangular connecting beam. The frame (3) can also be formed with layers of circular, polygonal, star-like, or irregular connecting rods to provide a better effect.

Accordingly, the present invention obviously gains the utility and novelty for patent and is thus applied.

What is claimed is:

1. A three-dimension curtain-type lighting string including a frame being formed by several layers of connecting beams, which are capable of being connected with many hanging strings with different length for becoming a three-dimension decoration.

2. The three-dimension curtain-type lighting string as claimed in claim 1, wherein the cross section of the beam can be rectangular, circular, or polygonal.

3. The three-dimension curtain-type lighting string as claimed in claim 1, wherein the layers of the connecting beams can be rectangular, circular, polygonal, star-like, or irregular
